(19) United States
(12) Patent Application Publication
(10) Pub. No.: US 2012/0286172 A1
(43) Pub. Date: Nov. 15, 2012

(54) Collection of Atmospheric Ions

(75) Inventors: Ryan Coulson, Golden, CO (US); Bryce Jones, Golden, CO (US); Michael Hurowitz, Boulder, CO (US)

(73) Assignee: Sefe, Inc., Tempe, AZ (US)

(21) Appl. No.: 13/106,759

(22) Filed: May 12, 2011

(51) Int. Cl. G21K 1/00

(52) U.S. Cl. 250/489

(57) ABSTRACT

The subject matter described herein relates to a method for collection of atmospheric ions subject to an electron avalanche associated with a gas multiplication effect between parallel plate collectors. A voltage source can be provided. The voltage source can provide a voltage that can cause a high electric field between two consecutive plates of the plurality of parallel plates. The high electric field can cause an electron avalanche that can cause electron multiplication. Energy associated with these multiplied electrons can be extracted, and studied to give insight into where the most abundant source of atmospheric charge is located. Related apparatus, systems, techniques and articles are also described.

### TECHNICAL FIELD

The subject matter described herein relates to collection of atmospheric ions subject to an electron avalanche associated with an electron cascade, or Townsend Avalanche, effect between charged plates that causes electron multiplication.

### BACKGROUND

Cosmic rays are energetic charged subatomic particles that can originate from outer space (or the void existing beyond any celestial body including earth) and that can impinge on atmosphere of the earth. Cosmic rays can produce secondary particles that can penetrate the surface of the earth. The secondary particles can also be referred as cosmic ray daughter particles. When these cosmic rays and cosmic ray daughter particles interact with atmospheric gases and each other, ion pairs can be generated in atmosphere of the earth. Specifically, at low to moderate elevations, these ion pairs can be generated by a nucleon-electromagnetic cascade that can be initiated by bombardment of primary energetic cosmic rays in the high atmosphere and interactions of these primary cosmic rays with the daughter particles. During these interactions, ion pairs can be created when valence electrons are stripped from their corresponding parent molecules, thereby generally resulting in a free electron and a positively charged ion. Under normal conditions, the free electron and the positively charged ion can either recombine or diffuse away from each other. To collect energy associated with these ion pairs, it can be advantageous to amplify creation of the ion pairs (i.e., amplify creation of free electrons and positively charged ions), collect charges associated with the ion pairs, and measure concentration of the ion pairs.

To collect energy, a collection scheme that includes a single conductor can be used. However, this single conductor collection scheme may not alter the recombination or diffusion of the ion pairs, because a sufficient electric field may not be created unless there are two differing potentials in close proximity. Moreover, with respect to the single conductor detection scheme, the collection/harvesting of atmospheric ions can be subject to geographical and atmospheric conditions, such as elevation, latitude, humidity, cloud presence, and the like. Accordingly, it can be advantageous to overcome dependence on these natural conditions by employing a parallel plate collector providing two differing potentials in close proximity, thereby inducing an electron cascade (or Townsend Avalanche) to drastically increase the number of charged particles, and reduce recombination and diffusion with an electric field between the two parallel plates.

### SUMMARY

A parallel plate collector including a plurality of parallel plates is presented to collect atmospheric ions subject to an electron avalanche associated with a gas multiplication effect between the parallel plates. A voltage source can be provided. The voltage source can provide a voltage that can cause a high electric field between two consecutive plates of the plurality of parallel plates. The high electric field can cause an electron avalanche associated with a gas multiplication effect which increases the available number of charged particles for collection. The charged particles can be measured as a current between two consecutive parallel plates. This current is proportional to the number of charged particles between two consecutive parallel plates. The number of charged particles is directly proportional to the magnitude of the electric field, thus for a given observed current and applied electric field the initial number of charged particles can be calculated. This measurement is useful in classifying the availability of energy in the atmosphere. Related apparatus, systems, techniques and articles are also described.

In one aspect, an apparatus to collect atmospheric ions includes a plurality of parallel plates and a voltage source. The voltage source provides a voltage that causes a high electric field between two consecutive plates of the plurality of parallel plates. The high electric field causes an electron cascade from the atmospheric ions causing electron multiplication at a collector associated with the plurality of parallel plates.

In another aspect, an apparatus to collect atmospheric ions includes a plurality of parallel plates. The apparatus further includes a voltage source providing a voltage that causes a high electric field between two consecutive plates of the plurality of parallel plates. The high electric field causes an electron cascade from the atmospheric ions. The apparatus further includes a collector associated with the plurality of parallel plates for receiving the electron cascade as a multiple of the atmospheric ions.

The subject matter described herein provides many advantages. For example, collection of charges associated with ion pairs and measurement of concentration of the ion pairs can enable determining atmospheric charge density characterization, and can provide an insight into nature of charge distribution in atmosphere.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an electrical configuration of a parallel plate collector consistent with some implementations of the current subject matter; and

FIG. 2 illustrates another electrical configuration of a parallel plate collector consistent with some implementations of the current subject matter.

When practical, similar reference numbers denote similar structures, features, or elements.

### DETAILED DESCRIPTION

To address these and potentially other issues with currently available solutions, one or more implementations of the current subject matter provide methods, systems, articles or manufacture, and the like to collect atmospheric ions subject to an electron avalanche associated with a gas multiplication effect between charged parallel plates.

The electron avalanche can be a process in which free electrons in a medium (e.g. gas) can be subjected to strong acceleration by an electric field, thereby ionizing atoms of the medium by collision and forming daughter/secondary electrons that can undergo the same process in successive cycles.

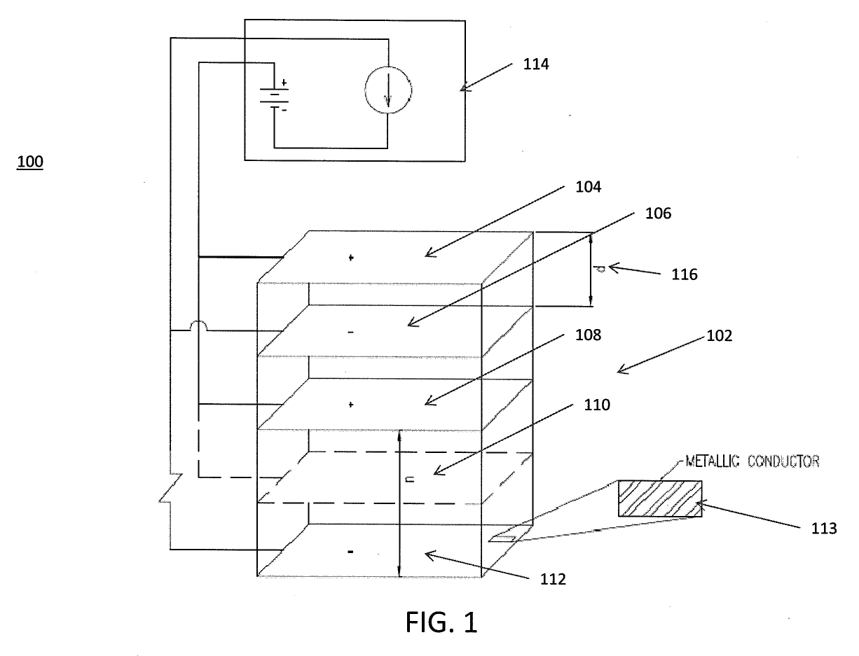

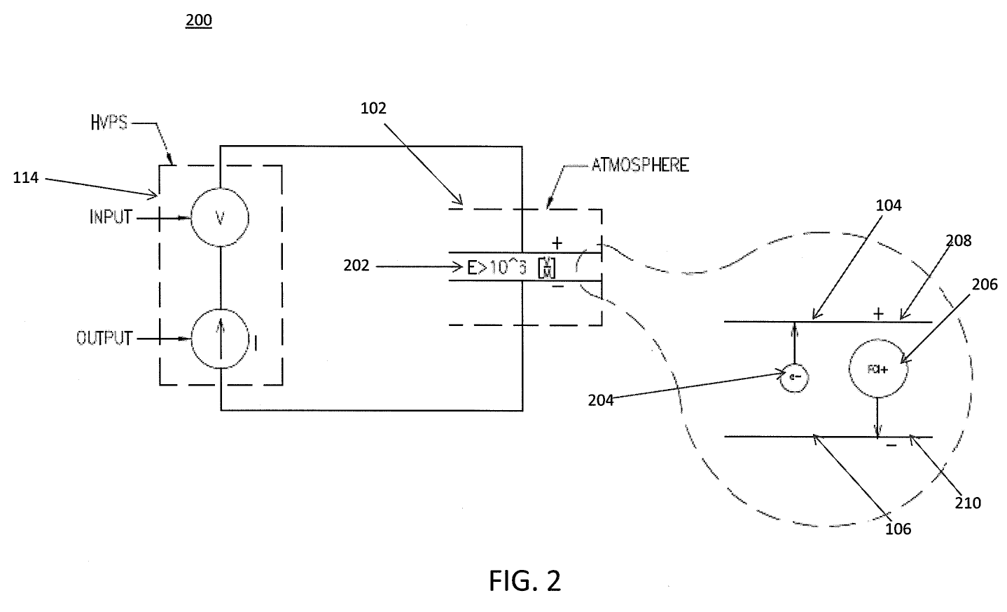

FIG. 1 illustrates an electrical configuration 100 of a parallel plate collector 102. The parallel plate collector 102 can include parallel plates 104, 106, 108, 110, and 112 having corresponding charged surfaces. Although five parallel plates are illustrated in FIG. 1, note that any number (two or more) of plates can exist. The parallel plates can be made of a conducting material 113, which can be a metal or an alloy, such as one of or a combination of gold, silver, copper, aluminum, and the like. Co-occurring plates can have opposite charges on corresponding surfaces. For example, plate 104 can have a positively charged surface, plate 106 can have a negatively charged surface, plate 108 can have a positively charged surface, and plate 112 can have a negatively charged surface, and so on. A sufficiently high direct current (DC) electric field 202 (shown in FIG. 2) can be generated between two co-occurring plates (e.g. 104, 106; or 106, 108; or the like) by the voltage/power supply 114.

The resulting current can be measured. This current can be proportional to the number of free electrons 204 (shown in FIG. 2) present in the atmosphere confined between the two co-occurring plates 104, 106. Any two co-occurring plates (e.g. 104, 106; or 106, 108; or the like) can be separated from each other by a separation distance “d” 116. In one implementation, the separation distance 116 can be a constant predetermined value for any two co-occurring plates (e.g. 104, 106; or 106, 108; or the like). In another implementation, distances between different co-occurring plates (e.g. 104, 106; or 106, 108; or the like) can vary according to a pre-defined algorithm. Each plate (104, 106, 108, 110, or 112) can be held at a constant DC voltage with respect to the plate (if any) above it and the plate (if any) below it.

The parallel plate collector 102 can be deployed below an aircraft to collect atmospheric ions. In other implementations, the parallel plate collector 102 can be deployed on any entity moving in the atmosphere, such as a helicopter, a parachute, an air jet, and the like. In some implementations, the parallel plate connector can be deployed on a stationary device. When deployed below an aircraft, a mobile high voltage power supply 114 and a data acquisition system can be placed in a cockpit of the aircraft, and operations and positioning of the parallel plate collector 102 can be controlled by a laptop associated with the cockpit. The laptop associated with the cockpit can be present either in the cockpit or in a control room on the ground.

FIG. 2 illustrates another electrical configuration 200 of the parallel plate collector 102. Gas multiplication (or electron avalanche) can cause electron multiplication. This effect can be implemented to drastically amplify the number of charged particles available for collection, while at the same time reducing recombination and diffusion of the charged particles 202. Electron multiplication can occur in presence of a sufficiently high electric field 202 (e.g. electric field greater than or equal to 10⁶ V/m). Atmospheric ions 204, 206 can migrate across the electric field 202 generated between two plates 104, 106 (or any other two co-occurring/neighboring plates) of the parallel plate collector 102.

This electric field 202 can be created between two conductive surfaces 208, 210 of opposite polarity relative to each other. The two conductive surfaces 208, 210 can be a positively charged anode 208 and a negatively charged cathode 210. In a parallel plate configuration with a separation distance of 1 cm between any two co-occurring plates (e.g. 104, 106; or 106, 108; or the like), the threshold (or minimum voltage at which gas multiplication or electron avalanche occurs) voltage can be 10 kV.

When creation of an ion pair (free electron 204 and positively charged ion 206) occurs in the presence of an electric field 202, the resulting free electron 204 can transverse the electric field 202 towards the positively charged anode 208. Conversely, the positively charged ion 206 can transverse the electric field 202 towards the negatively charged cathode 210. There can be a free electron amplification process generated in the presence of the high electric field 202, such that the free electron amplification process causes a multiplication of the free electrons 204. This multiplication of the free electrons 204 can be referred to as Townsend avalanche or a Townsend discharge, which, under correct circumstances, can multiply the total number of ions created by factors of many thousands. The Townsend avalanche discharge is a gas ionization process in which a small number of free electrons 204 can be accelerated by a strong electric field 202 to give rise to electrical conduction through a gas by avalanche multiplication.

Most of the electrons (initial+avalanche−diffusion−recombination) collide with the positively charged plate. This flow of elections from between the two plates can be thought of as a current through a variable resistor between two consecutive plates. The resistance is indirectly proportional to the DC electric field between the plates. As the electric field is increased (above the threshold field strength) the resistance drops and more current flows from one plate to the other. There is a correlation between the current and the initial number of charged particles at any given electric field. The purpose of the field is simply to amplify the signal high enough above noise levels that it can be digitized and studied.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. An apparatus to collect atmospheric ions, the apparatus comprising:
a plurality of parallel plates; and
a voltage source providing a voltage that causes a high electric field between two consecutive plates of the plurality of parallel plates, the high electric field causing an electron cascade from the atmospheric ions causing electron multiplication at a collector associated with the plurality of parallel plates.

2. The apparatus of claim 1, wherein each parallel plate is at a predetermined distance from a neighboring plate.

3. The apparatus of claim 1, wherein each parallel plate has a charged surface comprising charge opposite to charge on a charged surface of a neighboring plate.

4. The apparatus of claim 1, wherein the high electric field is a direct current electric field.

5. The apparatus of claim 1, wherein surface of each plate comprises a conducting material.

6. An apparatus to collect atmospheric ions, the apparatus comprising:
a plurality of parallel plates;
a voltage source providing a voltage that causes a high electric field between two consecutive plates of the plurality of parallel plates, the high electric field causing an electron cascade from the atmospheric ions; and
a collector associated with the plurality of parallel plates for receiving the electron cascade as a multiple of the atmospheric ions.

7. The apparatus of claim 6, wherein each parallel plate is at a predetermined distance from a neighboring plate.

8. The apparatus of claim 6, wherein each parallel plate has a charged surface comprising charge opposite to charge on a charged surface of a neighboring plate.

9. The apparatus of claim 6, wherein the high electric field is a direct current electric field.

10. The apparatus of claim 6, wherein surface of each plate comprises a conducting material.
